(19) United States
(12) Patent Application Publication
(10) Pub. No.: US 2009/0216724 A1
(43) Pub. Date: Aug. 27, 2009

(54) NETWORK RESOURCES STRUCTURING SYSTEM

(75) Inventors: Jinnan Cai, Perth (AU); Raphael Patmore, Mount Claremont (AU); Lynton Beaumont-Bilsby, Bayswater (AU)

Correspondence Address: DAVIS WRIGHT TREMAINE, LLP/Seattle, 1201 Third Avenue, Suite 2200, SEATTLE, WA, 98101-3045, US

(73) Assignee: BUZKA PTY LTD, Subiaco (AU)

(21) Appl. No.: 12/359,474

(22) Filed: Jan. 26, 2009

(30) Foreign Application Priority Data
Jan. 25, 2008 (AU) 2008900356

(51) Int. Cl. G06F 17/30

(52) U.S. Cl. 707/3; 707/10; 707/E17.032; 707/E17.108

(57) ABSTRACT

A system is disclosed for structuring access to Internet resources which comprises a data storage device arranged to store information indicative of a plurality of Internet resources and information indicative of navigation paths between the Internet resources so that the Internet resources are organised in a hierarchical structure. The system is arranged to facilitate access to the hierarchical structure by a user.

### FIELD OF THE INVENTION

The present invention relates to a system for structuring access to network resources and, in particular, to structuring access to resources on the Internet.

### BACKGROUND OF THE INVENTION

In this specification, the terms “web page” and “website” will be understood to mean any Internet resource with a URL, such as images, PDF files, audio and/or video files, and so on.

It is known to use a computer to search for Internet resources by entering keywords representative of a desired website using a search website, the search website using the entered keywords to locate potentially relevant websites based on occurrence of the keywords on the websites.

However, such an arrangement for locating desired websites is relatively imprecise to the extent that websites not directly relevant are often produced which requires significant user review. Several separate pages detailing large numbers of website hyperlinks are also often produced which takes significant time to view. This is cumbersome and time consuming.

### SUMMARY OF THE INVENTION

In accordance with a first aspect of the present invention, there is provided a system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

In one arrangement, the data storage device is arranged to store data representative of folders and data representative of hyperlinks, the folders being capable of containing hyperlinks.

In one embodiment, the hierarchical structure is modifiable by a user. The hierarchical structure may be modifiable so as to modify the position of a folder or hyperlink in the structure, or so as to modify the name of a folder or hyperlink.

The hierarchical structure may be modifiable so as to add an Internet resource to the structure. The position and/or name of the Internet resource may be selectable by a user.

In one arrangement, the system includes an associated web site and the system is accessible to view the hierarchical structure by directing a web browser to the web site.

In one embodiment, for each user the system includes a user home page and an associated user hierarchical structure, wherein a web page desired to be added to the user hierarchical structure is associated with the user hierarchical structure when a request is made for a URL including a portion relating to the user's home page and a portion relating to the web page desired to be added. The user's web browser may include an add page button and the URL request may be created in response to clicking the add page button, or by manual entry of the URL into a browser address bar.

The web site associated with the system may include an add page icon and the system may be arranged such that when the add page icon is dragged to a web browser by a user, an add web page button is created on the browser.

The system may be arranged so as to facilitate access to a global hierarchical structure containing Internet resources added by all users associated with the system.

In one embodiment, each folder is capable of including at least one child folder, and each folder which includes at least one child folder or hyperlink may be collapsible so as to hide the at least one child folder or hyperlink and expandable so as to display the at least one child folder or hyperlink. For this purpose, each folder which includes at least one child folder or hyperlink may include an open and/or close icon.

The system may further be arranged to facilitate searching of the hierarchical structure using keywords. The keywords may be used to search for matching folder names and/or matching combinations of parent/child folder names, and to display the results of the search in a hierarchical structure which is navigatable by a user. The system may be arranged so as to include matching folder names in the search results and so as to include hyperlinks contained in the matching folders in the search results. Where the search produces matching combinations of parent/child folder names, the system may be arranged so as to include hyperlinks contained only in the child folders of the matching combination of parent/child folders in the search results.

In accordance with a second aspect of the present invention, there is provided a system for searching Internet resources:
the system being arranged to organise Internet resources in a hierarchical structure, and to facilitate access to the hierarchical structure by a user through the Internet;
the Internet resources comprising data indicative of a plurality of hyperlinks and folders arranged to contain hyperlinks.

In accordance with a third aspect of the present invention, there is provided a computer program arranged, when loaded into a computing system, to cause the computing system to operate in accordance with a system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

In accordance with a fourth aspect of the present invention, there is provided a data storage medium readable by a computing device, the data storage medium having computer program code embodied therein which when loaded into a computing system is arranged to cause the computing system to operate in accordance with a system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

In accordance with a fifth aspect of the present invention, there is provided a method of structuring access to Internet resources comprising:
storing information indicative of a plurality of Internet resources and information indicative of navigation paths between the Internet resources so that the Internet resources are organised in a hierarchical structure; and
facilitating access to the hierarchical structure by a user.

In accordance with a sixth aspect of the present invention, there is provided a method of searching Internet resources comprising:
organising Internet resources in a hierarchical structure; and
facilitating access to the hierarchical structure by a user through the Internet;
the Internet resources comprising data indicative of a plurality of hyperlinks and folders capable of containing hyperlinks.

In accordance with a seventh aspect of the present invention, there is provided a method of searching resources organized into hierarchical folders, each folder having an associated folder name representative of resources contained in the folder, the method comprising:
receiving at least one keyword from a user;
searching the folder names using the at least one keyword; and
displaying resources based on matching folder names.

The at least one keyword may be used to search for matching folder names and/or matching combinations of parent/child folder names, and to display the results of the search in a hierarchical structure which is navigatable by a user. The system may be arranged so as to include matching folder names in the search results and so as to include resources contained in the matching folders in the search results. Where the search produces matching combinations of parent/child folder names, the system may be arranged so as to include resources contained only in the child folders of the matching combination of parent/child folders in the search results.

### DESCRIPTION OF THE DRAWINGS

The present invention will now be described, by way of example only, with reference to the accompanying drawings, in which:

FIG. 1 is a schematic diagram of a network resources structuring system in accordance with an embodiment of the present invention shown during use in relation to a distributed network;

FIG. 2 is a diagrammatic representation of a login page produced by the system shown in FIG. 1;

FIG. 3 is a diagrammatic representation of a user home page produced by the system shown in FIG. 1;

FIG. 4 is a diagrammatic representation of the user home page shown in FIG. 3 and including a comment box;

FIG. 5 is a diagrammatic representation of an organize resources page produced by the system shown in FIG. 1;

FIG. 6 is a diagrammatic representation of a save hyperlink page produced by the system shown in FIG. 1;

FIG. 7 is a diagrammatic representation of a new folder page produced by the system shown in FIG. 1;

FIG. 8 is a diagrammatic representation of the user home page shown in FIG. 3 and including an additional function box;

FIG. 9 is a diagrammatic representation of an add button page produced by the system shown in FIG. 1;

FIG. 10 is a diagrammatic representation of a friends page produced by the system shown in FIG. 1;

FIG. 11 is a diagrammatic representation of a friends group page produced by the system shown in FIG. 1;

FIG. 12 is a diagrammatic representation of an add friends page produced by the system shown in FIG. 1;

FIG. 13 is a diagrammatic representation of an explore page produced by the system shown in FIG. 1;

FIG. 14 is a diagrammatic representation of a global hierarchical structure produced by the system shown in FIG. 1;

FIG. 15 is a diagrammatic representation of an explore members page produced by the system shown in FIG. 1;

FIG. 16 is a diagrammatic representation of a search page produced by the system shown in FIG. 1;

FIG. 17 is a diagrammatic representation of a table schema for resource records;

FIG. 18 is a schematic diagram representing the hierarchical relationship between resource records;

FIG. 19 is a diagrammatic representation of resource records extracted in response to a search; and

FIG. 20 is a flow diagram illustrating an add hyperlink operation in accordance with the present invention.

### DESCRIPTION OF AN EMBODIMENT OF THE INVENTION

In the following description of an embodiment of the invention, although the embodiment is described in relation to a system essentially implemented using software running on a conventional computing system, it will be understood that the invention may as an alternative be implemented in hardware or a combination of hardware and software.

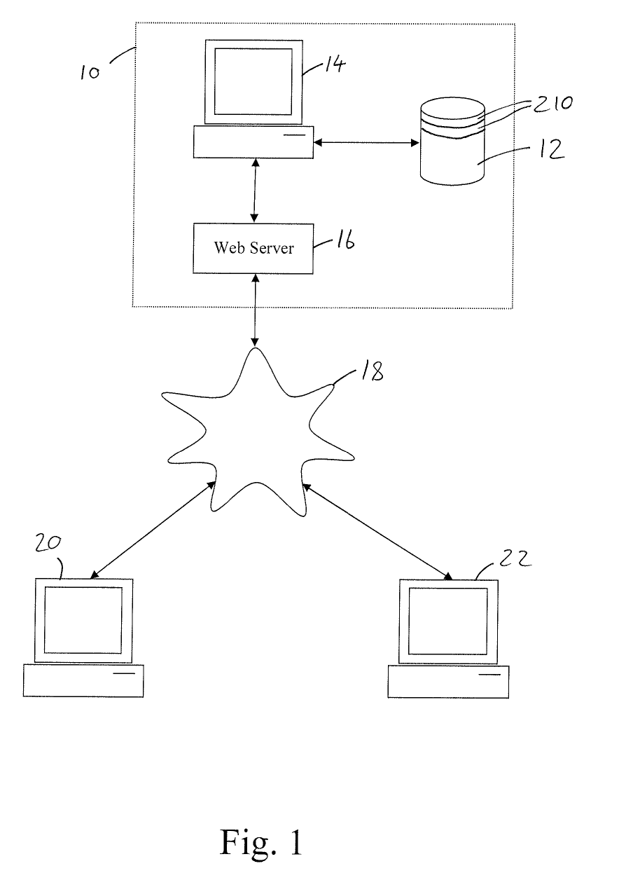

Referring to the drawings, in FIG. 1 there is shown a network resources structuring system 10 connected during use to a distributed network, in this example the Internet 18, and to remote computing devices 20, 22. In this example, the computing devices 20, 22 are in the form of personal computers, although it will be understood that any device capable of connecting to a distributed network and receiving information pages, in this example web pages, is envisaged.

The system 10 includes a data storage device, in this example in the form of a database 12, a control unit, which in this example is a computing device in the form of a personal computer 14, and a server, in this example a web server 16 arranged to serve web pages to the Internet 18.

While FIG. 1 shows the database 12 and the server 16 separate to the computing device 14, it will be understood that the database 12 and/or the server 16 may be incorporated into the computing device 14. For example, the database 12 may be implemented using a hard drive of the computing device 14 and appropriate software of the computing device 14, and the server 16 may be implemented using software installed on the computing device 14.

It will also be understood that the web server 16 and the database 12 may be implemented using separate computing devices.

While the present embodiment is described in relation to a distributed network including the Internet which is arranged to distribute web pages with associated computer code and protocols, it will be understood that any suitable distributed network is envisaged, the important aspect being that the distributed network is capable of connecting together multiple remote computing devices and distributing information pages between the computing devices.

The system 10 is configured so as to facilitate creation and modification of a hierarchical structure of network resources by users from any computing device 20, 22 connected to the Internet 18 by facilitating creation and modification of folders within the hierarchical structure and enabling users to add hyperlinks to web pages to folders in the structure.

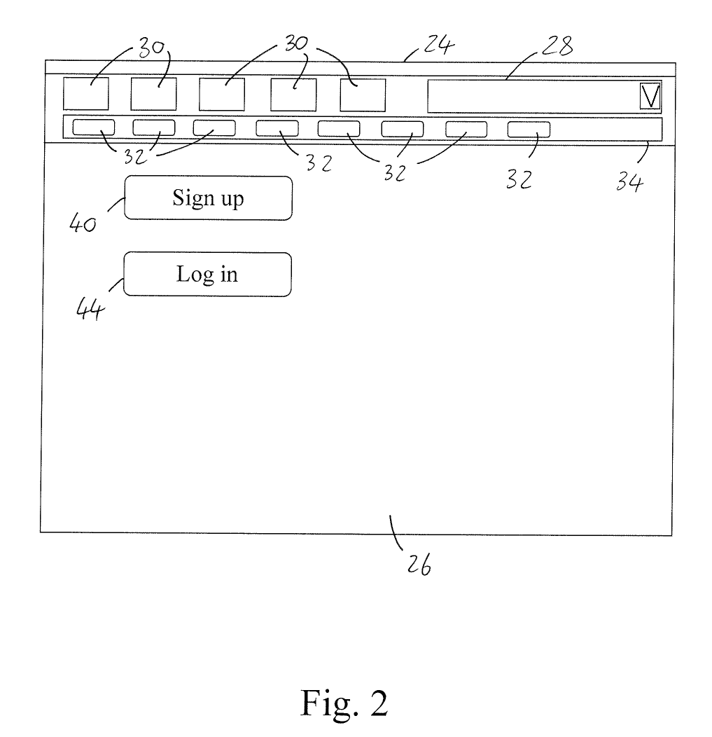

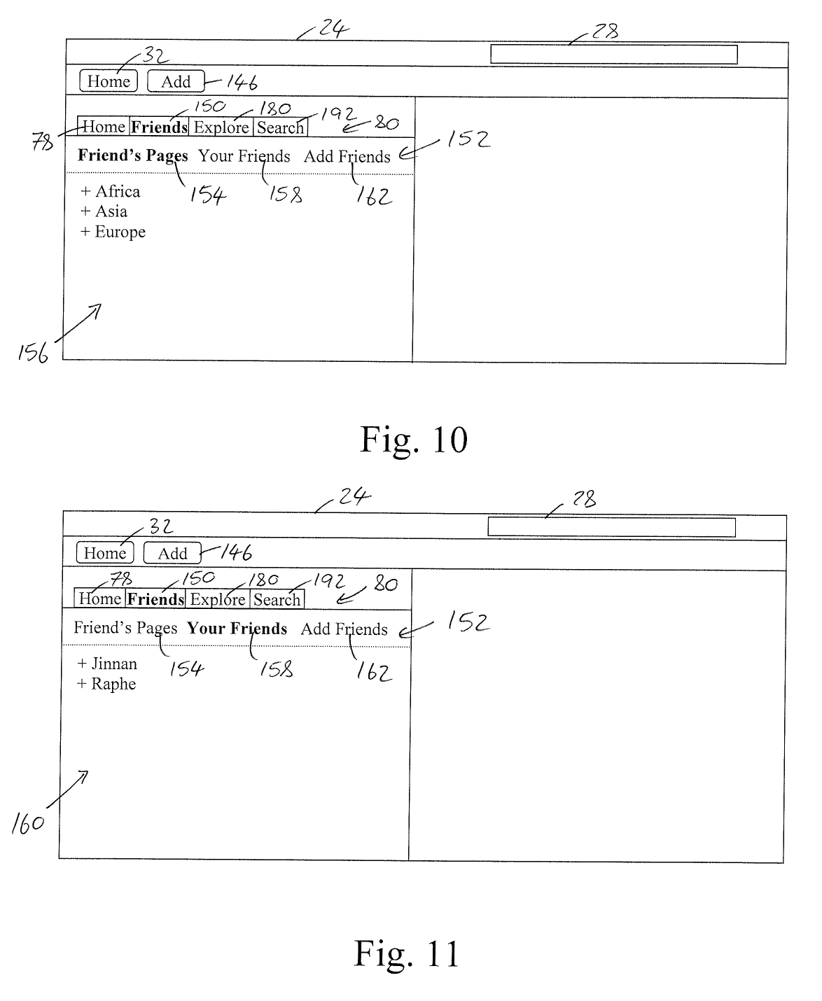

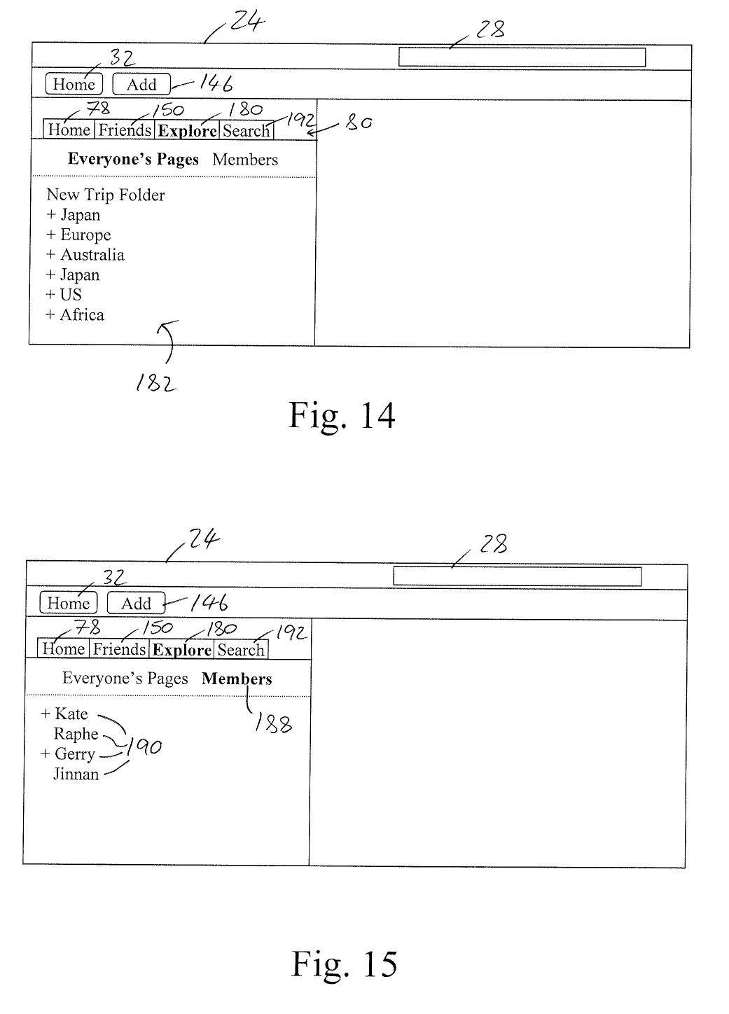

An example implementation of the system 10 is shown in FIGS. 2 to 19. Each of the Figures is a representation of a screen presented to a user of a computing device connected to the system 10 through the Internet 18.

In this example, the system 10 is accessed using a remote computing device 20, 22, for example by using a web browser 24 installed on a remote computing device 20, 22.

As shown in FIG. 2, a login page 26 is first displayed to a user when the user connects to the system 10 using the web browser 24.

The web browser 24 shown in FIG. 2 is a conventional web browser and includes an address bar 28 usable to enter addresses of websites, browser function buttons 30 usable to control functionality of the web browser 24, and link buttons 32 disposed in a links tool bar 34, each of the link buttons 32 being associated with a hyperlink to a website such that clicking on the link button 32 causes the web browser 24 to be directed to the website address associated with the link button 32.

The login page 26 also includes a sign-up button 40 and a login button 44.

If the user has not yet signed up with the system 10, the user is required to complete a sign up procedure which is initialised by clicking on the sign up button 40. If the user is already registered with the system, the user clicks on the login button 44 which instigates a login procedure requiring the user to enter a login name and a password in order to verify the identity of the user.

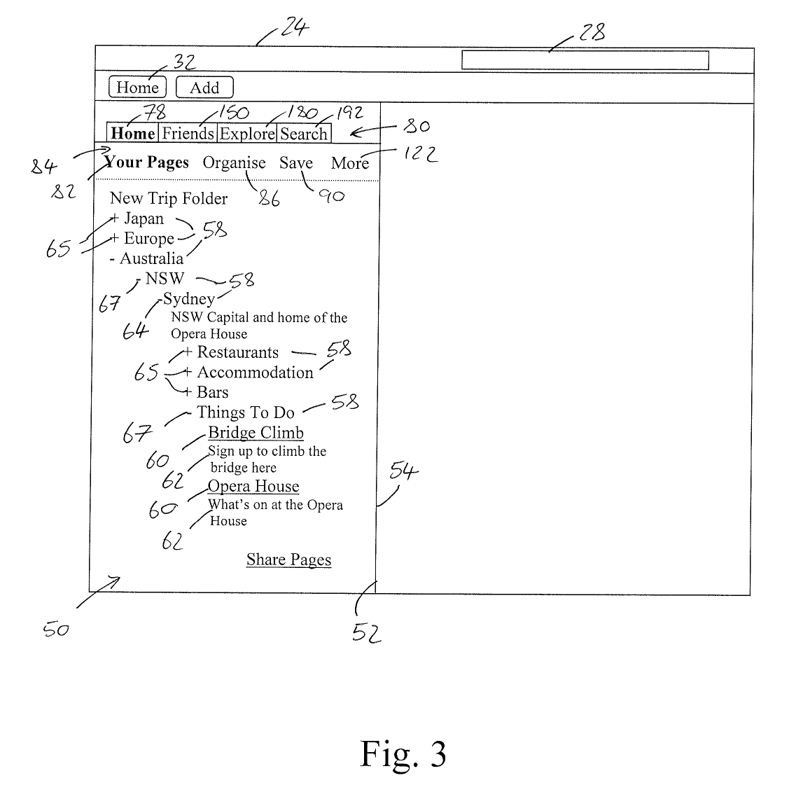

After successful login, a user home page 50 as shown in FIG. 3 is displayed on the web browser 24 in a system window 52.

When a user logs into the system 10, an active session is created by storing a unique alphanumeric token in the database 12 and on the user computing device 20, 22 as a browser cookie. In the present example, the browser cookie is created with an expiry time of the order to 30 to 60 minutes. When the browser cookie expires, the user is required to log into the system again.

The system 10 is arranged such that each registered user has an associated user home page 50 as shown in FIG. 3.

When connected to the user home page 50, the browser 24 displays the system window 52 and a web page window 54. The home page 50 displays a hierarchical structure of folders 58 and hyperlinks 60 to websites. The titles of the folders 58, the titles of the hyperlinks 60 and the relative locations of the folders 58 and the hyperlinks 60 in the folder structure 56 have been determined by the user associated with the home page 50.

In this example, each hyperlink 60 may also have a user definable description 62 which is optional. The user may also optionally add a description 64 to a folder 58.

In addition to displaying text to describe folders 58, an icon and/or thumbnail image representative of the content of at least some of the folders may be displayed.

Any parent resources that contain child search results have an associated closed icon 65 showing the parent resource in a closed state. Clicking on the closed icon 65 will change the closed icon to an open icon 67 and trigger the interface to display the child resources belonging to the parent resource.

The resource titles 60 represent hyperlinks that can be clicked by the user to direct the browser 24 to the Internet resource referenced by its URI. If the resource has no URI, then no action occurs if the user clicks on the title 60.

Single resources are represented as list items without an icon 65, 67.

When a user clicks on a closed icon 65, the icon will change into an open icon 67 to represent that the resource is in an open state. The interface will also refresh to append and make visible the list of child resources immediately following the parent resource. The position of any sibling resources below the parent resource will shift downwards. In one embodiment of this interface, Javascript may be used to dynamically trigger the display of elements on the page without the need to refresh the entire interface.

Child resources belonging to a parent resource in the open state are displayed by indenting each child, or by any other design that communicates the hierarchical relationship of each child to its parent. Child resources that are also parents themselves are shown initially to the user in their closed state, represented by a closed icon 65. Child resources belonging to a parent are hidden from view until the user clicks on a closed icon 65 or title 60 of a parent resource in the closed state.

If a user clicks on an open icon 67, the open icon 67 will change into a closed icon 65 and the parent resource will change back to its closed state. The interface will refresh to hide all child resources belonging to the parent resource as well as any visible children of its children from view. The result list will appear to collapse and any sibling resources below the parent resource in the closed state will shift upwards.

In the situation where a large number of results are found, it is appropriate to limit the number of results displayed per screen and allow the user to navigate between more pages of results by clicking on navigation buttons (not shown) representing “previous page” “next page” and “page numbers” below the list of results.

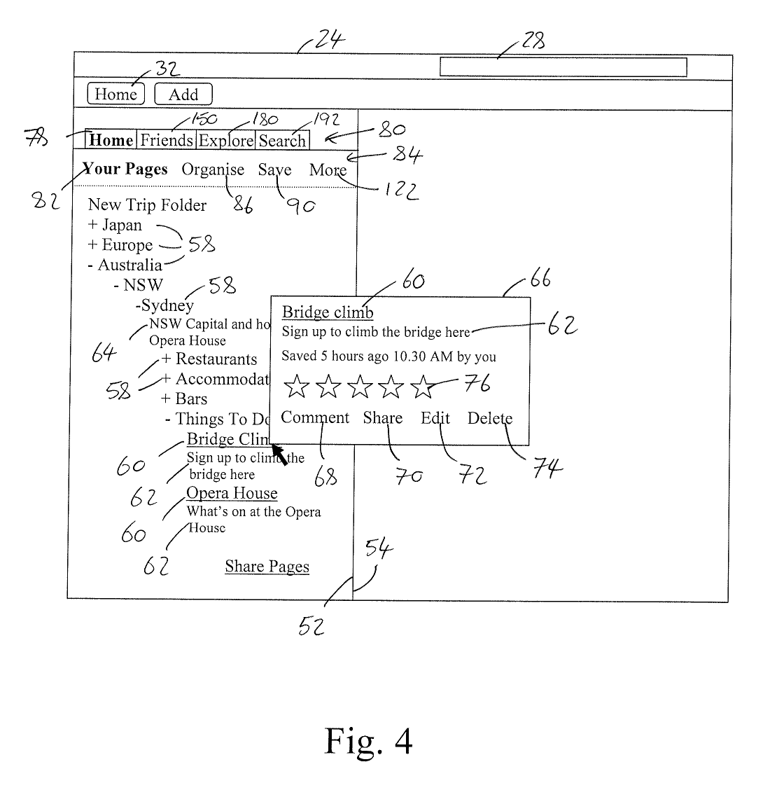

Each hyperlink 60 also has an associated comment box 66 which may be displayed by disposing a mouse pointer over the hyperlink 60, as shown in FIG. 4. When the comments box 66 is displayed, the user has the option to add a comment by activating a comment link 68, share access to the hyperlink 60 with other users of the system by activating a share link 70, edit the title 60 or description 62 of the hyperlink by activating an edit link 72, or delete the hyperlink by activating a delete link 74. The comment box 66 also includes a rating indicator 76, in this example is in the form of a series of stars which change colour when activated by the user.

The home page 50 is accessible by activating a homepage link 78 on a global navigation toolbar 80, and by activating a pages link 82 on a home navigation toolbar 84.

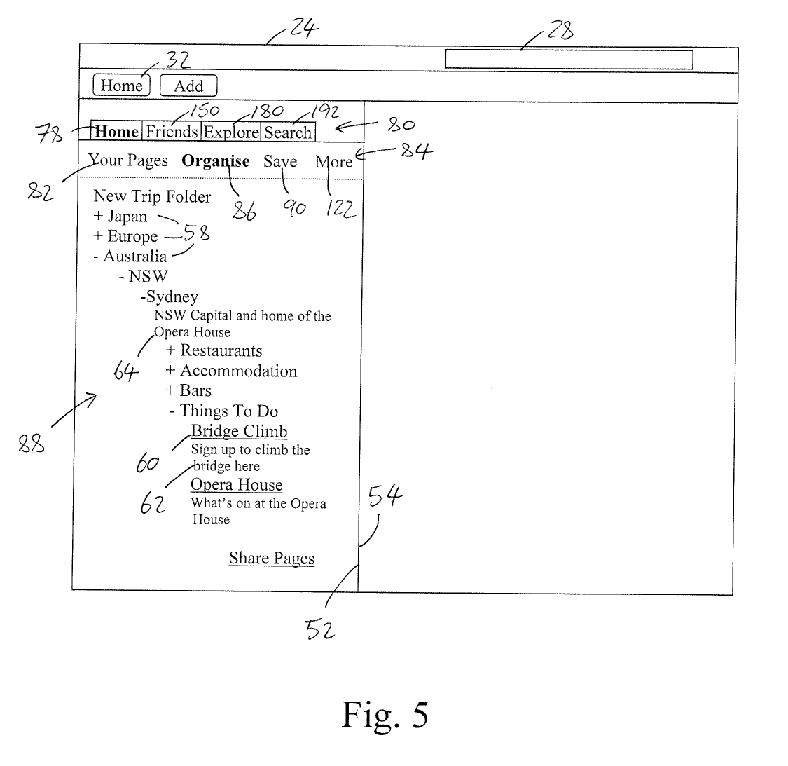

As shown in FIG. 5, by activating an organize link 86 on the home navigation toolbar 84 a modifiable folder structure 88 is displayed which permits a user to add, move, delete, rename and copy folders 58, hyperlinks 60 and descriptions 62, 64, in this example using a mouse.

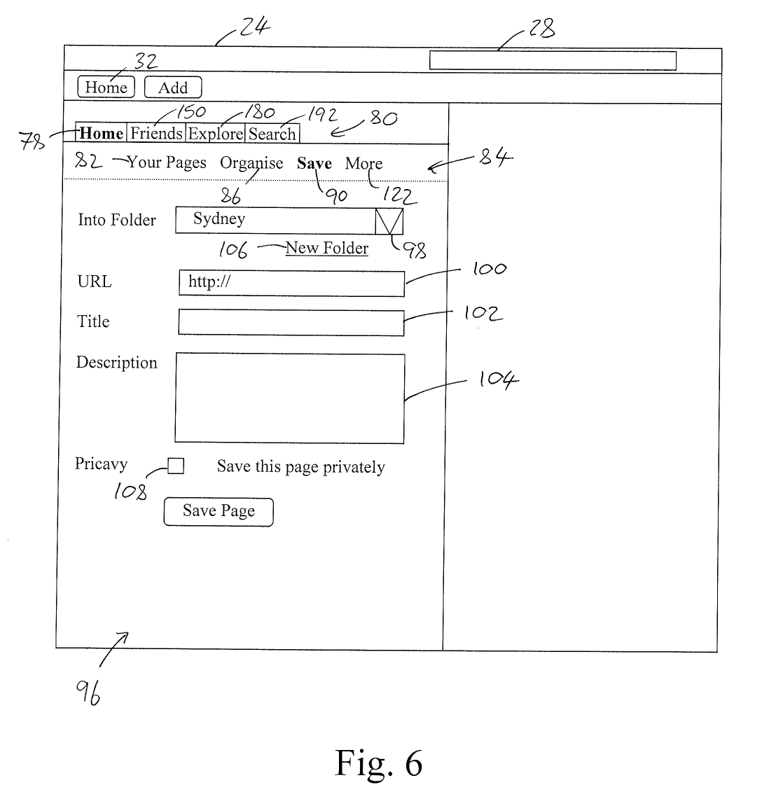

As shown in FIG. 6, by activating a save link 90 on the home navigation toolbar 84, a save hyperlink page 96 is displayed. The save hyperlink page 96 includes a destination folder drop down box 98 usable to select a folder 58 into which details of the new hyperlink will be placed, a URL box 100 usable to enter the website address associated with the hyperlink to be added, a title box 102 usable to enter a title for the hyperlink 60, a description box 104 usable to enter descriptive text relevant to the hyperlink 60, and a save button 106 usable to confirm the entered information.

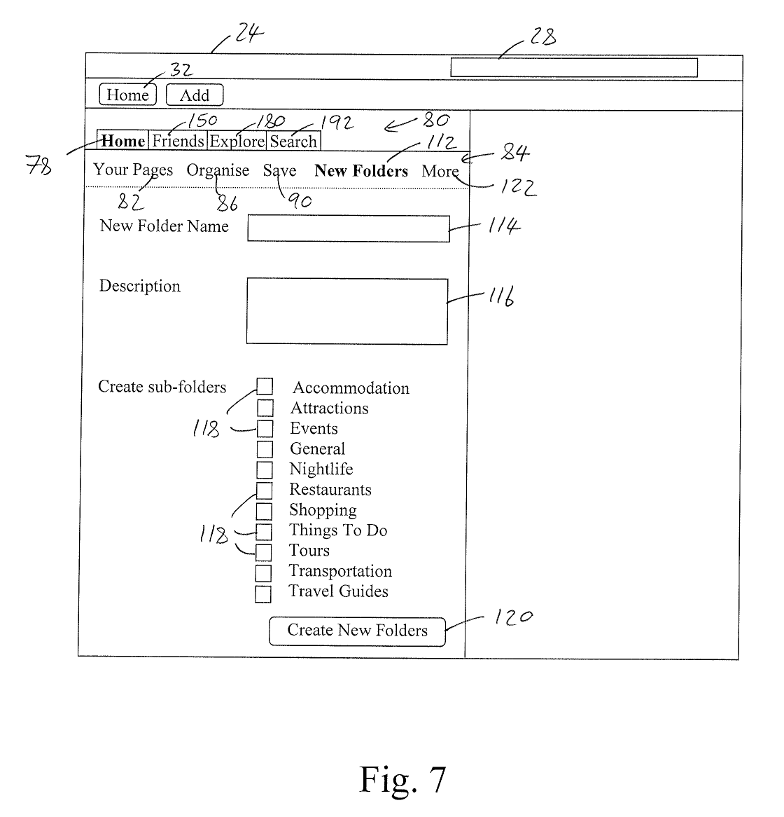

The save hyperlink page 96 also includes a new folder link 106 which when activated displays a new folder screen 110 as shown in FIG. 7, and a privacy check box 108 which when activated provides an indication to the system that the new hyperlink is not to be made available for viewing by other users of the system 10.

The new folder page 110 includes a new folder name box 114, a folder description box 116 usable to enter descriptive text relevant to the new folder. The new folder page 110 also includes in this example sub-folder checkboxes 118 usable to create predefined sub-folders. Activation of a create new folder button 120 confirms the entered information.

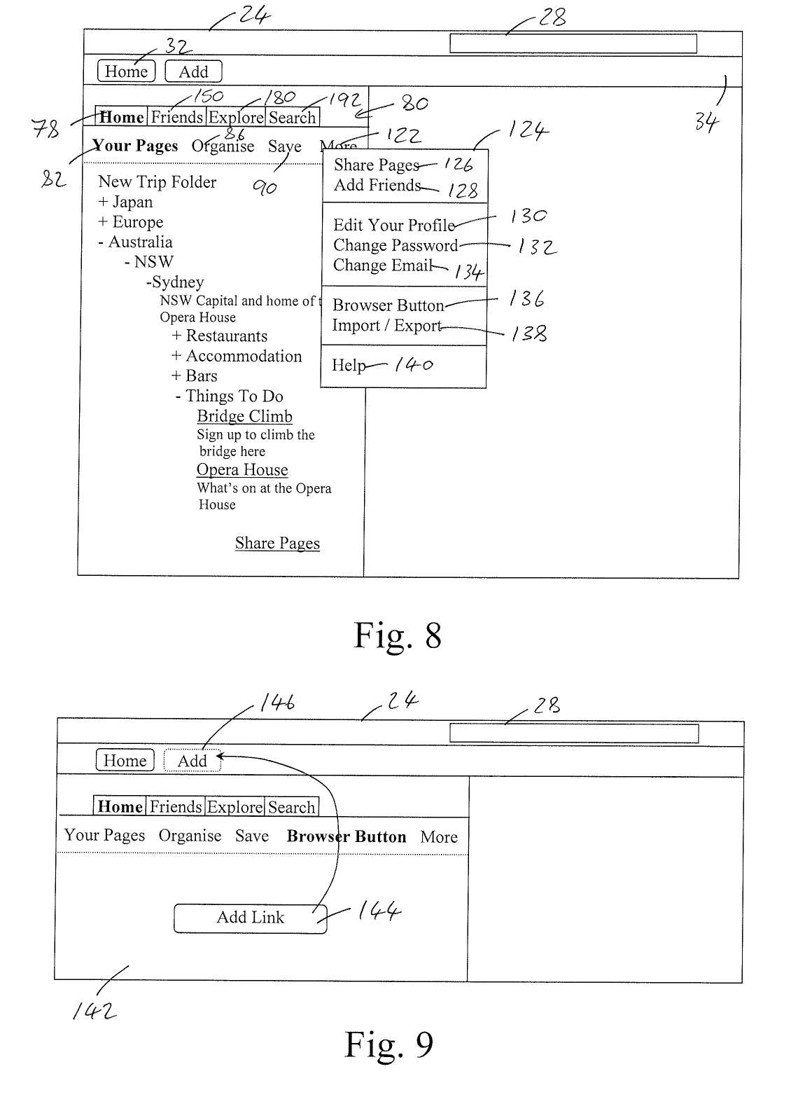

The home navigation toolbar 84 also includes an additional options link 122 which when activated causes display of an additional options box 124 as shown in FIG. 8, for example when a mouse pointer is disposed over the additional options link 122.

The additional options box 122 includes a share pages link 126, an add friends link 128, an edit profile link 130, a change password link 132, a change email link 134, a browser button link 136, an import/export link 138, and a help link 140.

Activation of the browser button link 136 causes an add button page 142 to be displayed, as shown in FIG. 9. The add link window includes an add link icon 144.

In order to configure the browser 24 for ease of addition of hyperlinks 60 to the hierarchical folder structure, the system 10 is arranged such that the add link icon 144 may be dragged to the links toolbar 34 which causes an add hyperlink button 146 to be created on the links toolbar 34. Operation of the add hyperlink button 146 is such that clicking on the add hyperlink button 146 causes a web page displayed by the browser 24 to be added to a folder 58 in the hierarchical folder structure associated with the user. In this example, clicking on the add hyperlink button 146 causes the save hyperlink window 96 to be displayed which facilitates selection of the folder 58 into which the hyperlink 60 will be saved and addition of a title and optionally descriptive text 62.

The global navigation toolbar 80 also includes a friends link 150 which when activated causes display of a friends toolbar 152. By activating a friends pages link 154 in the friends toolbar 152, a combined hierarchical folder structure 156 is displayed which includes folders and hyperlinks added by all users which have been linked together on the system as friends. In this way, it is possible for a user to not only view web pages associated with hyperlinks which the user has added to the hierarchical folder structure, but to also view web pages associated with hyperlinks 60 added by other users linked to the user as friends.

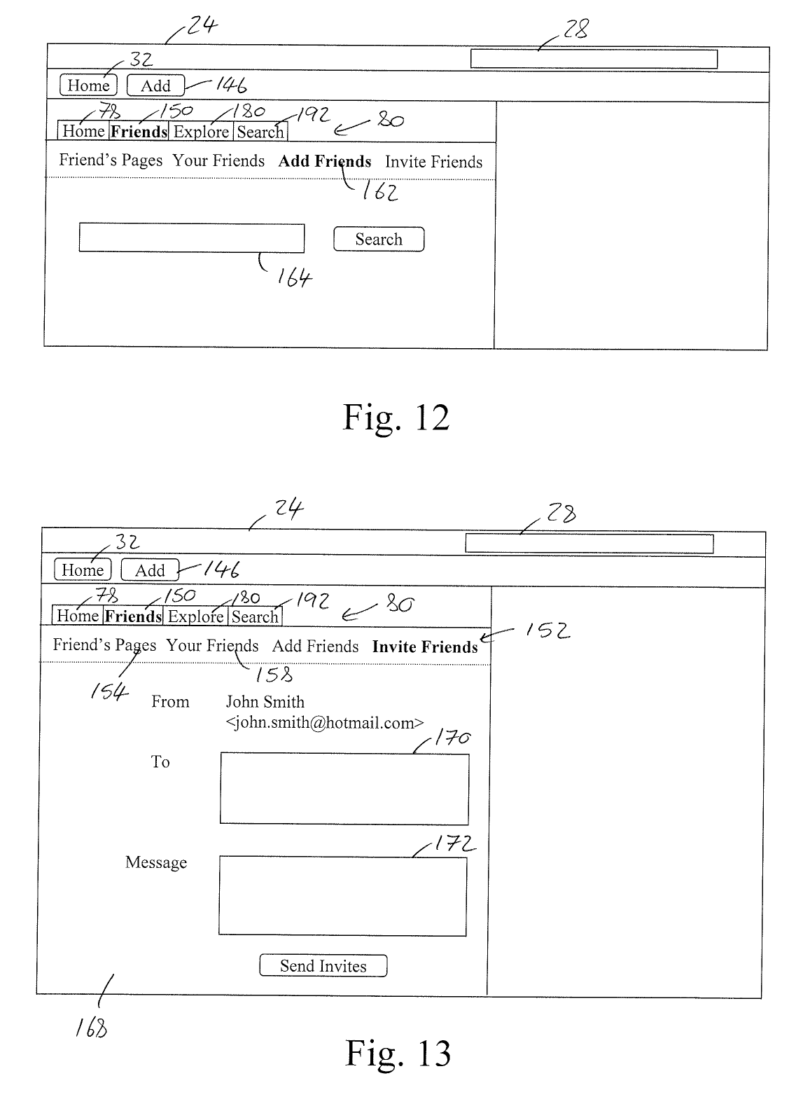

By activating a your friends link 158, a friends group 160 comprising users which have been linked together as friends may be viewed, as shown in FIG. 11. New friends may be added and thereby linked to the friends group 160 by activating an add new friends link 162, searching for friends using a friend search box 164 as shown in FIG. 12, and inviting located friends to join the friends group using a friends invite screen 168, as shown in FIG. 13. Using the friends invite screen, a user is able to add email addresses into an invite to box 170, and optionally include a text message in a message box 172 to be sent with the invite.

The global navigation toolbar 80 also includes an explore link 180 which when activated causes display of a global hierarchical folder structure 182. The global hierarchical folder structure 182 includes folders 58 and hyperlinks 60 added to the system 10 by all users associated with the system 10. Using the global hierarchical folder structure 182, a user is able to navigate to a desired website hyperlink by opening appropriate folders and subfolders in the global structure. The global hierarchical folder structure 182 excludes hyperlinks 60 which have been marked private using the privacy check box 108.

As shown in FIG. 15, as an alternative a user is also able to view the hierarchical folder structure associated with a selected user by activating a members link 188 so as to display users 190 associated with the system, and selecting one of the users 190.

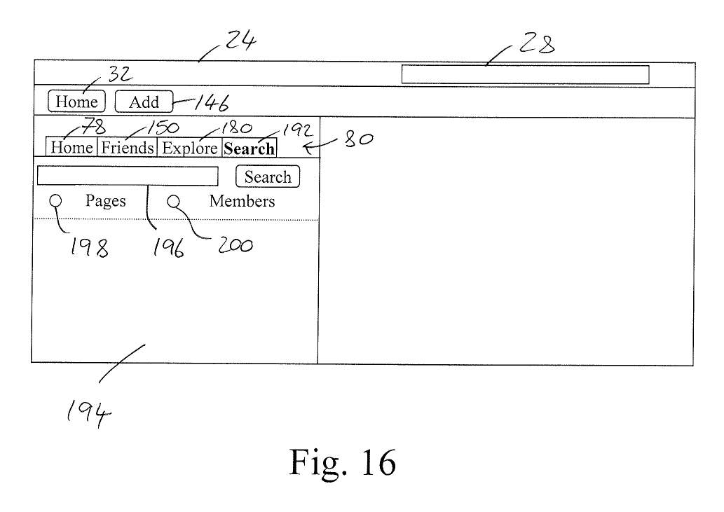

A user is also able to search the global hierarchical folder structure 182 by activating a search link 192 on the global navigation toolbar 80. When the search link 192 is activated, a search page 194 as shown in FIG. 16 is displayed. The search page 194 includes a search box 196 and user selectable pages and members checkboxes 198 and 200 respectively.

When the pages checkbox 198 is activated and text is entered into the search box 196, the system carries out a search for folders 58 and hyperlinks 60 using the entered text and the located folders 58 and associated hyperlinks 60 are displayed.

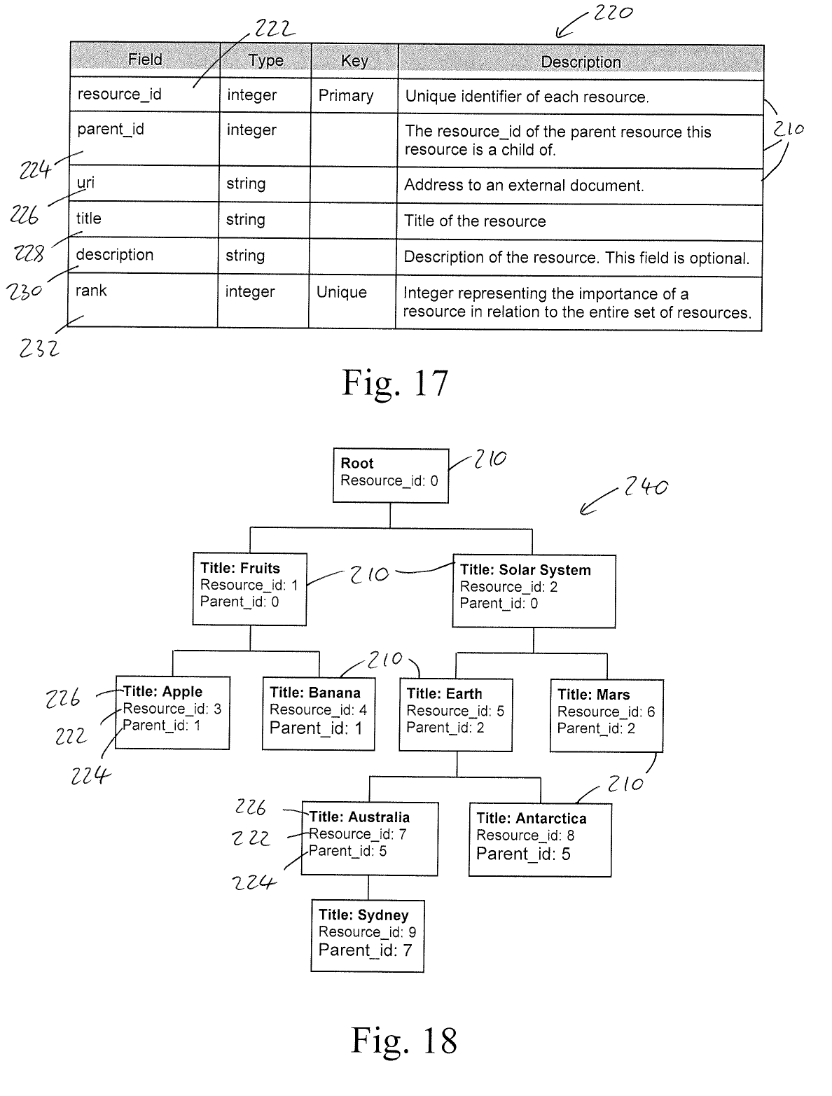

Each resource in the hierarchical structure is stored in the database as a record 210. A table schema 220 for resource records is shown in FIG. 17.

Each resource 210 in the table 220 has a unique primary key 222 identified by resource_id, and a parent_id field 224 usable to link the resource to a parent resource, for example when the resource is a sub-folder or a hyperlink contained in a folder or sub-folder. Each resource also has a URI field 226, a title field 228, a description field 230 and a rank field 232.

Resources belonging to the root of the hierarchy are assigned a root parent_id which may be 0 or NULL.

The URI field 226 can contain a hyperlink address to an external Internet resource, or it can be empty such that a resource is not associated with a hyperlink, for example when the resource is a folder.

The title and description fields 228, 230 correspond respectively to the titles 58, 60 and descriptions 62, 64 in the displayed hierarchical folder structure.

The rank field 232 stores a rank identifier, in this example an integer representing the importance of the resource in relation to other resources in the database.

The lower the integer, the higher the rank and therefore importance. The rank is calculated by an algorithm that considers a combination of variables logged by the system, including but not limited to the number of clicks by users on a resource, the number of users that have saved the same link, user ratings and comments on a resource, and the position of the resource in the user's folder structure.

An example hierarchical structure 240 illustrating the respective relationships between records 210 is shown in FIG. 18.

The system 10, in this example the computing device 14, is arranged to query the records 210 in the database 12 based on search criteria entered using the search page 194 such that the results of the search are organized into a hierarchical structure.

In one arrangement, the system 10 is arranged to query the records 210 so as to search for resource titles and/or descriptions in the resource table schema which contain entered keywords.

In one embodiment the database 12 is provided with the capability of a full text search engine and search index wherein the full text search engine can return a list of results matching one or more of a series of text query keywords, and a corresponding index of scores representing relevance to the search query.

After a list of matching resources has been returned by the search engine, a hierarchical search process is applied to derive the search results.

The hierarchical search process comprises two parts, a first part wherein primary resources matching the search query are obtained, and a second part wherein all child resources which belong to the parent resources obtained in first part of the search process are extracted from the database 12.

In one example, a search query “fruits” results in the following primary resources:

Tropical Fruits

Fruit facts

Citrus Fruits

which are derived from the following portions of the database hierarchy:

Tropical Fruits

Banana

Mango

Pineapple

Fruit facts

Citrus Fruits

Orange

Lemon

Citrus Fruits

Lime

Beverages

Tropical Fruits

Coconut

Using the above methodology, the system produces the following search result:

Tropical Fruits

Banana

Mango

Pineapple

Coconut

Fruit facts

Citrus Fruits
Orange
Lemon
Lime

It will be understood that where multiple resources of the same name exist in the database, their child resources are grouped together in the search results and appear as children of the matching parent resource.

If a search query includes more than one significant search term, the system may be arranged to compare a combination of parent and child resource names with permutations of the search terms in order to extract potentially relevant resources from the database.

For example, a search query “Hotels Beijing” should extract the following folders from the database:

Hotels Beijing

Beijing Hotels

as well as:

Hotels
Beijing

Beijing
Hotels

Accordingly, for a search query containing 2 significant terms, 4 possible folder name permutations are possible.

Similarly, a search query “Hotels Beijing China” should extract the following folders from the database:
Hotels Beijing China
Hotels China Beijing
Beijing Hotels China
Beijing China Hotels
China Hotels Beijing
China Beijing Hotels
Hotels
   Beijing China
Hotels
   China Beijing
Beijing
   Hotels China
Beijing
   China Hotels
China
   Hotels Beijing
China
   Beijing Hotels
Hotels Beijing
   China
Beijing Hotels
   China
China Hotels
   Beijing
Hotels China
   Beijing
China Beijing
   Hotels
Beijing China
   Hotels

Therefore, for a query containing 3 significant search terms, 18 possible folder name permutations are possible

In the present example, child folders are added to the search results according to the following criteria:

1. If the search query matches the name of a single folder resource, all children of the resource are added to the search results.

2. If a permutation of the search query matches a parent - child folder combination, only children of the child folder of the combination are added to the search results and other child folders of the parent folder are not added to the search results.

3. Where there is more than one set of matching folder name permutations, the children of the matching folder permutation are grouped and appended to a single name-matching parent folder.

In one example, a search query “Beijing China Hotels” results in the following primary resources:

Accommodation
Beijing China Hotels
   China World Hotel
   Crowne Plaza Beijing

China Hotels Beijing
Hilton Beijing

China Travel
Hotels
   Beijing China
      Ritz-Carlton Beijing
      Shangri-La Hotel

China Hotels
Beijing
   Peninsula Beijing
   Grand Hyatt Beijing

Hotels China
Beijing
   Radisson SAS

In one embodiment, the matching folder names and their children are appended to the search results. With this embodiment and using the above methodology, the system produces the following search result:

Beijing China Hotels
China World Hotel
Crowne Plaza Beijing

China Hotels Beijing
Hilton Beijing

Beijing China
Ritz-Carlton Beijing
Shangri-La Hotel

Beijing
Peninsula Beijing
Grand Hyatt Beijing
Radisson SAS

In an alternative embodiment wherein only child resources belonging to matching folder names are appended to the search results, the system produces the following search result:

China World Hotel

Crowne Plaza Beijing

Hilton Beijing

Ritz-Carlton Beijing

Shangri-La Hotel

Peninsula Beijing

Grand Hyatt Beijing

Radisson SAS

It is possible that the database will contain multiple records matching the search query which will be returned by the full text search. It is also possible that the combined search result including will contain duplicate resources by name or URI.

In one embodiment of the hierarchical search method, a duplicate resource by name or URI of highest rank is retained and other resources of lesser ranking are removed from the search results.

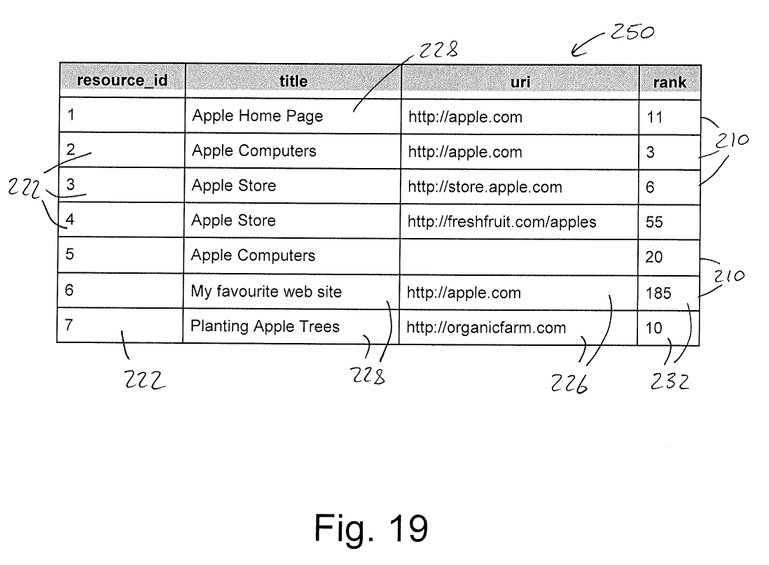

For example, a full text search produces the records shown in FIG. 19.

If multiple resources share the same URI 226, but have different titles 228 (in this example resources 1, 2 and 6), then the resource having the highest rank (in this example resource 2) is retained and the remaining duplicates are removed.

If multiple resources share the same title, but have different URIs (in this example resources 3 and 4, and resources 2 and 5), the resource of the highest rank (in this example resources 2 and 3) is retained and the remaining duplicates are removed.

Resources that have unique titles and URIs (in this example resource 7) in the search results are retained.

An example of the system during use will now be described.

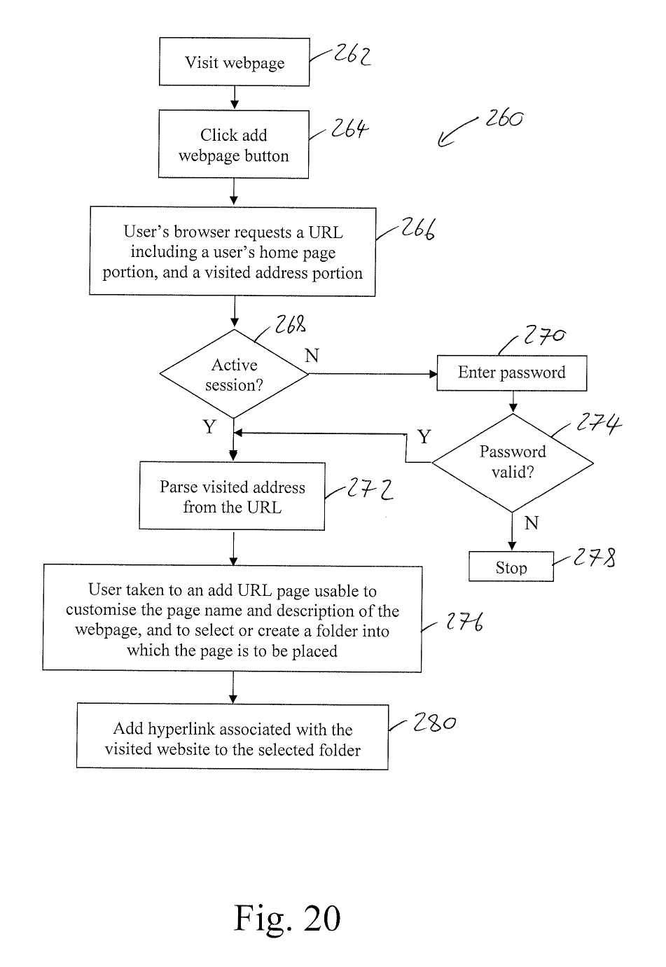

As illustrated by method steps 262 to 280 in a flow diagram 260 in FIG. 20, in order to add a web page to a user's folder structure, the user directs the web browser 24 to the web page desired to be added and clicks on the add web page button 146. This causes the browser 24 to request a URL including a portion indicative of the user's home page and a portion indicative of the address of the desired web page to be added. In one particular embodiment, the browser 24 requests a URL of the type http://username.buzka.com/webaddress. The portion of the URL “username.buzka.com” is the address of the user's home page 50 and the portion of the URL “web address” is the address of the web page desired to be added to the user's folder structure. However, it will be understood that other variations are possible.

After requesting the URL, the system 10 determines whether an active session exists for the user. If not, the user is directed to the login page 26 shown in FIG. 2 and is requested to enter a password.

After verification of an active session, the system 10 parses the URL into a user page address and a website address associated with the website desired to be added. The user is then directed to the save hyperlink page 96 as shown in FIG. 6 and the user is requested to select the folder 58 into which the website will be added, and to add a title and optionally description.

Resources saved by the user may be accessed by means of a URL of the type:

http://username.buzka.com/Folder Name/Child Folder Name

The portion of the URL “username.buzka.com” is the address of the user's home page. The portion of the URL “Folder Name/Child Folder Name” is the hierarchical path to a folder containing pages saved by the user.

Where the invention is implemented in software, or partly implemented in software, the invention may take the form of program code stored or available from computer readable media, such as CD-ROMS or any other machine readable media, the program code comprising instructions which, when loaded into a computing device cause the computing device to operate in accordance with the invention.

Modifications and variations as would be apparent to a skilled addressee are deemed to be within the scope of the present invention.

1. A system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

2. A system as claimed in claim 1, wherein the data storage device is arranged to store data representative of folders and data representative of hyperlinks, the folders being capable of containing hyperlinks.

3. A system as claimed in claim 1, wherein the hierarchical structure is modifiable by a user.

4. A system as claimed in claim 3, wherein the hierarchical structure is modifiable so as to modify the position of a folder or hyperlink in the structure, or so as to modify the name of a folder or hyperlink.

5. A system as claimed in claim 3, wherein the hierarchical structure is modifiable so as to add an Internet resource to the structure.

6. A system as claimed in claim 5, wherein the position and/or name of the Internet resource is selectable by a user.

7. A system as claimed in claim 1, wherein the system includes an associated web site and the system is accessible to view the hierarchical structure by directing a web browser to the web site.

8. A system as claimed in claim 1, wherein for each user the system includes a user home page and an associated user hierarchical structure, wherein a web page desired to be added to the user hierarchical structure is associated with the user hierarchical structure when a request is made for a URL including a portion relating to the user's home page and a portion relating to the web page desired to be added.

9. A system as claimed in claim 8, wherein the URL request is created in response to clicking an add page button on a web browser.

10. A system as claimed in claim 8, wherein the URL request is created by manual entry of the URL into a web browser address bar.

11. A system as claimed in claim 7, wherein the web site associated with the system includes an add page icon and the system is arranged such that when the add page icon is dragged to a web browser by a user, an add web page button is created on the browser.

12. A system as claimed in claim 1, wherein the system is arranged so as to facilitate access to a global hierarchical structure containing Internet resources added by all users associated with the system.

13. A system as claimed in claim 2, wherein each folder is capable of including at least one child folder, and each folder which includes at least one child folder or hyperlink is collapsible so as to hide the at least one child folder or hyperlink and expandable so as to display the at least one child folder or hyperlink.

14. A system as claimed in claim 13, wherein each folder which includes at least one child folder or hyperlink includes an open and/or close icon.

15. A system as claimed in claim 1, wherein the system is arranged to facilitate searching of the hierarchical structure using keywords.

16. A system as claimed in claim 15, wherein the keywords are usable to search for matching folder names and/or matching combinations of parent/child folder names, and to display the results of the search in a hierarchical structure which is navigatable by a user.

17. A system as claimed in claim 16, wherein the system is arranged so as to include matching folder names in the search results and so as to include hyperlinks contained in the matching folders in the search results.

18. A system as claimed in claim 16, wherein the system is arranged so as to include hyperlinks contained only in the child folders of the matching combination of parent/child folders in the search results when the search produces matching combinations of parent/child folder names.

19. A system for searching Internet resources, the system being arranged to organise Internet resources in a hierarchical structure, and to facilitate access to the hierarchical structure by a user through the Internet;
the Internet resources comprising data indicative of a plurality of hyperlinks and folders arranged to contain hyperlinks.

20. A computer program arranged, when loaded into a computing system, to cause the computing system to operate in accordance with a system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

21. A data storage medium readable by a computing device, the data storage medium having computer program code embodied therein which when loaded into a computing system is arranged to cause the computing system to operate in accordance with a system for structuring access to Internet resources comprising:
a data storage device arranged to store information indicative of a plurality of Internet resources and information indicative of navigation paths between the Internet resources so that the Internet resources are organised in a hierarchical structure;
the system being arranged to facilitate access to the hierarchical structure by a user.

22. A method of structuring access to Internet resources comprising:
storing information indicative of a plurality of Internet resources and information indicative of navigation paths between the Internet resources so that the Internet resources are organised in a hierarchical structure; and
facilitating access to the hierarchical structure by a user.

23. A method as claimed in claim 22, comprising storing data representative of folders and data representative of hyperlinks, the folders being capable of containing hyperlinks.

24. A method as claimed in claim 22, wherein the hierarchical structure is modifiable by a user.

25. A method as claimed in claim 24, wherein the hierarchical structure is modifiable so as to modify the position of a folder or hyperlink in the structure, or so as to modify the name of a folder or hyperlink.

26. A method as claimed in claim 24, wherein the hierarchical structure is modifiable so as to add an Internet resource to the structure.

27. A method as claimed in claim 26, wherein the position and/or name of the Internet resource is selectable by a user.

28. A method as claimed in claim 22, comprising providing an associated web site and facilitating access to view the hierarchical structure by directing a web browser to the web site.

29. A method as claimed in claim 22, comprising providing for each user a user home page and an associated user hierarchical structure, and associating a web page desired to be added to the user hierarchical structure with the user hierarchical structure when a request is made for a URL including a portion relating to the user's home page and a portion relating to the web page desired to be added.

30. A method as claimed in claim 29, comprising creating the URL request in response to clicking an add page button on a web browser.

31. A method as claimed in claim 29, comprising creating the URL request manually by entering the URL into a web browser address bar.

32. A method as claimed in claim 22, comprising facilitating access to a global hierarchical structure containing Internet resources added by all users associated with the system.

33. A method as claimed in claim 23, wherein each folder is capable of including at least one child folder, and each folder which includes at least one child folder or hyperlink is collapsible so as to hide the at least one child folder or hyperlink and expandable so as to display the at least one child folder or hyperlink.

34. A method as claimed in claim 22, comprising facilitating searching of the hierarchical structure using keywords.

35. A method as claimed in claim 34, comprising using keywords to search for matching folder names and/or matching combinations of parent/child folder names, and displaying the results of the search in a hierarchical structure which is navigatable by a user.

36. A method as claimed in claim 35, comprising including matching folder names in the search results and hyperlinks contained in the matching folders in the search results.

37. A method as claimed in claim 35, comprising including hyperlinks contained only in the child folders of the matching combination of parent/child folders in the search results when the search produces matching combinations of parent/child folder names.

38. A method of searching Internet resources comprising:
organising Internet resources in a hierarchical structure; and
facilitating access to the hierarchical structure by a user through the Internet;
the Internet resources comprising data indicative of a plurality of hyperlinks and folders capable of containing hyperlinks.

39. A method of searching resources organized into hierarchical folders, each folder having an associated folder name representative of resources contained in the folder, the method comprising:
receiving at least one keyword from a user;
searching the folder names using the at least one keyword; and
displaying resources based on matching folder names.

40. A system as claimed in claim 39, wherein the at least one keyword is used to search for matching folder names and/or matching combinations of parent/child folder names, and to display the results of the search in a hierarchical structure which is navigatable by a user.

41. A system as claimed in claim 40, wherein the system is arranged so as to include matching folder names in the search results and so as to include resources contained in the matching folders in the search results.

42. A system as claimed in claim 41, wherein the system is arranged so as to include resources contained only in the child folders of the matching combination of parent/child folders in the search results when the search produces matching combinations of parent/child folder names.
